(19) United States
(12) Patent Application Publication
(10) Pub. No.: US 2003/0088570 A1
(43) Pub. Date: May 8, 2003

(54) Systems and methods for operating a multi-user document device via a personal device portal

(75) Inventors: David M. Hilbert, San Jose, CA (US); Jonathan J. Trevor, Santa Clara, CA (US); William N. Schilit, Menlo Park, CA (US); James Pycock, St. Ives (GB)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 09/985,599

(22) Filed: Nov. 5, 2001

(51) Int. Cl. G06F 7/00

(52) U.S. Cl. 707/100

(57) ABSTRACT

A networked or non-networked multi-user document device is provided with a device portal and/or a personal portal. The device portal and/or the personal portal combine the functionality of an interface of the multi-user document device with access to information and/or resources that may be utilized with or may utilize the functionality or operating capabilities of the multi-user document device. The device portal and the personal portal expand the usefulness of the interface of the multi-user document device and the personal portal customizes or personalizes the interface for an identified user of the multi-user document device. The device portal and/or the personal portal enable various e-commerce capabilities for multi-user document devices.

### BACKGROUND OF THE INVENTION

1. Field of Invention

This invention relates to systems and methods for operating multi-user document device. More specifically, this invention relates to systems and methods for operating a multi-user document device via a device portal.

2. Description of Related Art

Personal and business needs often require the use of copiers, printers, scanners, facsimile machines and multifunction devices (hereafter, collectively referred to as “multi-user document devices”) inside and/or outside of an office environment. Inside an office, multiple users may utilize various devices to accomplish various business related tasks.

In some cases, small businesses may need access to multifunction devices without having to devote capital and office space to the devices. Even larger businesses that own or lease multifunction devices may need access to similar devices, for example, when an employee is on business travel or must work at a remote location. To this end, multifunction devices are made available to the general public, for example, at retail locations, coffee shops or the like, or to select users, for example, at hotels or business centers such as at airports.

It is known to network multifunction devices for integration with an office computer system so that the devices may receive information from multiple computer terminals or workstations. Further, it is known to network multifunction devices, for example, via the Internet. Such networking of multifunction devices using the Internet allows remote monitoring and/or servicing of the multifunction devices.

With regard to the Internet or the World Wide Web, e-commerce websites, such as Amazon.com, and portal websites, such as My.Yahoo.com provide users with a sense that the website “knows” or “remembers” them. For example, the website may provide a personal greeting when a particular user accesses the website with the users password or when a particular terminal having a small file or “cookie” associated therewith is used to access the website.

E-commerce websites may remember shipping addresses and/or credit card information from a prior order to expedite future purchases. Further, such websites may provide information regarding current promotions or targeted advertising, such as suggestions relating to products a user may want to buy, for example, based on their past shopping behavior.

Portal websites typically provide multiple general interest resources, such as news stories, sports scores, stock quotes, horoscopes and local weather, which may be personalized based on the user's information. Such information may include, for example, the user's personal data (age, birth date, sex, etc.), the user's interests and/or the user's location. The user may also be provided with targeted advertising based on the user's information.

### SUMMARY OF THE INVENTION

The systems and methods of this invention provide a device portal for a networked or non-networked multi-user document device.

The systems and methods of this invention separately provide a personal portal for a user of a networked or non-networked multi-user document device.

The systems and methods of this invention separately provide a single personal interface for a user across a plurality of networked or non-networked multi-user document devices.

The systems and methods of this invention separately provide a device portal that is embedded in a networked or non-networked multi-user document device.

The systems and methods of this invention separately provide user access to personal resources of the user and/or past interactions of the user with a networked or non-networked multi-user document device.

The systems and methods of this invention separately provide personalized information to a user based on the user's information.

The systems and methods of this invention separately provide a personal portal for a user of a networked or non-networked multi-user document device in which at least one of personal resources, shared resources, preferences and past interactions are persistent.

The systems and methods of this invention separately provide information to a user based on the location of the networked or non-networked multi-user document device.

The systems and methods of this invention separately provide information to a user based on at least one feature of the networked or non-networked multi-user document device.

The systems and methods of this invention separately provide user access to a personal portal on a networked or non-networked multi-user document device via an identification device.

The systems and methods of this invention separately provide a user portal for a user of a networked or non-networked multi-user document device that is accessible in an anonymous mode and in a personalized mode.

The systems and methods of this invention separately provide a personal portal that associates a user reward with each use of one or more select networked or non-networked multi-user document devices.

According to various embodiments of this invention, a method for operating a networked or non-networked multi-user document device comprises providing a multi-user document device with a device portal, and providing a user of the multi-user document device with information via the device portal based on at least one of an identity of the user and at least one feature of the multi-user document device.

In various embodiments of this invention, providing the user of the multi-user document device with information via the device portal is based on the location of the multi-user document device and comprises accessing resources associated with the location of the multi-user document device. Alternately or additionally, providing the user of the multi-user document device with information via the device portal is based on the location of the multi-user document device and comprises providing targeted advertising to the user via the device portal. In various embodiments of this invention, providing the user of the multi-user document device with information via the device portal is based on at least one feature of the multi-user document device and comprises accessing resources associated with the at least one feature of the multi-user document device.

In various embodiments of this invention, providing the user of the multi-user document device with information via the device portal is based on the identity of the user. In such embodiments, the method may further comprise identifying the user of the multi-user document device, and accessing a personal portal for the identified user. Further, identifying the user of the multi-user document device may comprise detecting an electronic tag associated with the user, reading an encoded card, such as a credit card or a smart card, associated with the user, receiving a key entry associated with the user, analyzing a biometric measurement and/or receiving a signal from a remote device operated by the user. In various embodiments, accessing the personal portal for the identified user comprises accessing personal resources stored on one or more devices.

In various embodiments of this invention in which providing the user of the multi-user document device with information via the device portal is based on the identity of the user, the method further comprises identifying the same user of a second multi-user document device, and accessing the same personal portal for the identified user via the second multi-user document device.

In various embodiments of this invention in which providing the user of the multi-user document device with information via the device portal is based on the identity of the user, the method further comprises storing at least one interaction of the user with a multi-user document device. According to such embodiments, accessing the personal portal comprises accessing the stored at least one interaction of the user.

In various embodiments of this invention in which the user of the multi-user document device is identified a personal portal for the identified user is accessed via the multi-user document device, the method may further comprise providing, to the identified user via the personal portal, information that is personalized for the identified user. Alternatively or additionally, the method may comprise providing targeted advertising to the identified user via the personal portal. Alternatively or additionally, the method may comprise associating a reward with use of at least one select multi-user document device.

According to various embodiments of this invention, a system for operating a multi-user document device comprises: at least one multi-user document device; an interface associated with the multi-user document device; a portal server that generates a device portal based on at least one of an identity of a user and at least one feature of the multi-user document device; and a network in communication with the multi-user document device, wherein the portal server provides the device portal to the interface associated with the multi-user document device by accessing at least one resource via the network.

In various embodiments of this invention, the system further comprises at least one resource device in communication with the network. In various embodiments, the resource device stores information associated with a location of the multi-user document device and the portal server generates the device portal by accessing the information associated with the location of the multi-user document device stored by the resource device. In various embodiments, the resource device stores information associated with the multi-user document device and the portal server generates the device portal by accessing the information associated with the multifunction device stored by the resource device.

In various embodiments of this invention, the system further comprises a user identification device associated with a user of the multi-user document device that identifies the user to the portal server. In various embodiments, the user identification device may comprise a key entry, an electronic tag, an encoded card, such as a credit card or a smart card, a biometric device and/or a signal from a remote device operated by the user.

In various embodiments of this invention in which the system includes a user identification device associated with a user of the multi-user document device that identifies the user to the portal server, the system further comprises at least one personal resource device connected to the network.. In various embodiments, the personal resource device stores information associated with the identified user and the portal server generates the device portal by accessing the information associated with the identified user stored by the personal resource device.

According to various embodiments of this invention, a method for operating a multi-user document device comprises inputting an identity of a user into a device portal of a multi-user document device, associating the identity of the user with a user identification device, and supplying the user identification device to the user. In various embodiments, supplying the user identification device to the user comprises supplying an encoded card to the user. In various embodiments, the method further comprises associating payment information with the user identification device.

In various embodiments of this invention, the method further comprises using the user identification device to verify the identify the user of a multi-user document device and accessing a personal portal associated with the user based on the verified identity of the user. In various embodiments, the method may further comprise providing targeted advertising to the user via the personal portal. Additionally or alternatively, the method may further comprise associating a reward with the identity of the user based on use of the multi-user document device via the personal portal.

According to various embodiments of this invention, a system for operating a non-networked multi-user document device comprises: at least one multi-user document device; an interface associated with the multi-user document device; and at least one resource device associated with at least one of the multi-user document device and the interface, wherein the resource device stores information for generating a device portal based on at least one of an identity of a user and at least one feature of the multi-user document device. In various embodiments of this invention, the resource device stores information associated with a location of the multi-user document device and the device portal is generated based on the location of the multi-user document device. In other various embodiments, the resource device stores information associated with the multi-user document device and the device portal is generated based on the information associated with the multi-user document device.

In various embodiments of this invention, the system further comprises a user identification device associated with a user of the multi-user document device that identifies the user to the interface. In various embodiments, the device portal is generated based on the identity of the identified user. The user identification device may comprise a key entry, an electronic tag, an encoded card, a biometric device and/or a signal from a remote device operated by the user.

In various embodiments of this invention in which the system includes a user identification device associated with a user of the multi-user document device that identifies the user to the interface, the system further comprises at least one personal resource device associated with at least one of the multi-user document device, the interface and the user identification device. In various embodiments, the personal resource device stores information associated with the identified user and the device portal is generated by accessing the information associated with the identified user stored by the personal resource device.

These and other features and advantages of the systems and methods of this invention are described in or are apparent from the following detailed description of exemplary embodiments.

### BRIEF DESCRIPTION OF THE DRAWINGS

Various exemplary embodiments of this invention will be described in detail with reference to the following figures, wherein:

FIG. 1 is a schematic representation of a system for operating a multi-user document device according to this invention;

FIG. 2 is an exemplary representation of an interface display of general resources associated with a device portal according to this invention;

FIG. 3 is an exemplary representation of an interface display when identifying a user of a multi-user document device according to this invention;

FIG. 4 is an exemplary representation of an interface display when accessing a personal portal according to this invention;

FIG. 5 is an exemplary representation of an interface display of a personal portal according to this invention;

FIGS. 6-12 are exemplary representations of personal resources associated with a personal portal according to this invention;

FIG. 13 is an exemplary block diagram of a system for operating a multi-user document device according to this invention;

FIG. 14 is another exemplary block diagram of a system for operating a networked multi-user document device according to this invention;

FIG. 15 is an exemplary block diagram of a system for operating a non-networked multi-user document device according to this invention; and

FIGS. 16-23 are exemplary flowcharts illustrating a method for operating a multi-user document device according to this invention.

### DETAILED DESCRIPTION OF PREFERRED EMBODIMENTS

According to the systems and methods of this invention, a networked or non-networked multi-user document device is provided with a device portal. Conventional multi-user document devices are operated using an interface, for example, a touch screen. According to this invention, the device portal combines the functionality of such an interface with access to information and/or resources that may be utilized with or may utilize the functionality or operating capabilities of the multi-user document device. As used throughout this specification, multi-user document devices include copiers, printers, scanners, facsimile machines, combinations thereof or similar known or hereafter developed devices, as opposed to a computer device such as a personal computer, a PDA or the like.

In various exemplary embodiments, the user of the multi-user document device may be provided with information via the device portal based on an identity of the user and/or a feature of the multi-user document device. For example, the user may be provided with information via the device portal based on the location of the multi-user document device, the owner/lessor of the multi-user document device, the manufacturer of the device or the like.

When the user is provided with information via the device portal based on the location of the multi-user document device, resources associated with the location may be accessed. For example, local news sources or local news information may be provided via the device portal. Other types of information include entertainment-related content, such as comics and horoscopes, business-related content, such as local restaurants and movie listings/reviews, and mapping applications, such as local maps, directions from “here” and nearby amenities including other portal-enabled devices. Alternately or additionally, targeted advertising may be provided to the user via the device portal. For example, coupons or current specials for local businesses may be provided.

Similarly, when the user is provided with information via the device portal based on other features of the multi-user document device, resources associated with the particular feature(s) of the multi-user document device may be accessed. For example, the user may be provided with access to a database of Internal Revenue Service forms via the device portal of a multi-user document device that is owned, leased or “sponsored” by a tax preparation business. Also, for example, when the multi-user document device is located at and/or owned by a particular business, organizationally relevant documents, such as company news or press releases, may be provided.

Alternatively or additionally, the user may be provided with information via the device portal based on the identity of the user so that the device portal is personalized or, in other words, is a personal portal. When a personal portal for the identified user is accessed, information that is personalized for the identified user is provided to the identified user. Alternatively or additionally, targeted advertising may be provided to the identified user via the personal portal. Alternatively or additionally, a reward may be associated with use of at least one select multi-user document device. Such a reward could provide an incentive for a user to increase usage of the select multi-user document device(s) or to use only select multi-user document device(s), for example, of a particular owner or manufacturer.

When the user is provided with information via the device portal based on the identity of the user, the user of the multi-user document device is identified so that a personal portal for the identified user may be accessed. According to various embodiments, identifying the user of the multi-user document device may comprise detecting an electronic tag associated with the user, receiving a key entry associated with the user, analyzing a biometric measurement of the user and/or receiving a signal from a remote device operated by the user. Any other suitable method, either known or hereafter developed, that is capable of identifying a user may be used as well.

Accessing the personal portal for the identified user may comprise accessing personal resources stored on one or more devices. For example, if the multi-user document device is networked, the device(s) may be accessed via the network. Alternatively or additionally, an identification device that is used to identify the user of the multi-user document device may also store personal resources. For example, if the multi-user document device is not networked, personal resources may be accessed from the identification device when it is arranged to be in communication with the device portal, such as when it is used to identify the user.

The systems and methods of this invention allow a personal portal to be provided across various multi-user document devices. For example, in various embodiments of this invention in which providing the user of the multi-user document device with information via the device portal is based on the identity of the user, the same user of a second multi-user document device is identified so that the same personal portal for the identified user may be accessed. It should be understood that, where the information provided via the device portal is also based on at least one feature of the multi-user document device, non-personal information and/or resources may still vary between the different multi-user document devices.

When the user of the multi-user document device is provided with information via the device portal based on the identity of the user, at least one interaction of the user with the multi-user document device may be stored, either on a storage device associated with the multi-user document device or on a remote storage device. In such a case, accessing the personal portal comprises accessing the stored at least one interaction of the user. This allows the multi-user document device(s) to “remember” interactions, such as user preferences of settings on the multi-user document device(s), so that use of the multi-user document device by the user is enhanced.

According to various embodiments of this invention, a system for operating a networked multi-user document comprises: at least one multi-user document device; an interface associated with the multi-user document device; a portal server that generates a device portal based on at least one of an identity of a user and at least one feature of the multi-user document device; and a network in communication with the multi-user document device, wherein the portal server provides the device portal to the interface associated with the multi-user document device by accessing at least one resource via the network. The multi-user document device may communicate directly with the network. Alternatively, the multi-user document device may communicate with the network via the interface.

One or more resource devices may also be in communication with the network. Such resource devices may store information associated with a location of the multi-user document device. In that case, the portal server generates the device portal by accessing the information associated with the location of the multi-user document device stored by the resource device(s). Alternatively or additionally, such resource devices may store information associated with another feature of the multi-user document device. In that case, the portal server may generate the device portal by accessing the information associated with other feature of the multi-user document device stored by the resource device(s).

In embodiments in which a personal portal is provided, a user identification device is associated with a user of the multifunction device that identifies the user to the portal server. The user identification device may comprise a key entry, an electronic tag, a biometric device and/or a signal from a remote device operated by the user. Any other suitable device or means, either known or hereafter developed, that is capable of identifying an individual or group of individuals may be used as the identification device.

In various embodiments of this invention in which the system includes a user identification device, at least one personal resource device may be connected to the network. The personal resource device stores information associated with the identified user so that the portal server may generate the device portal, a personal portal, by accessing the information associated with the identified user stored by the personal resource device.

In other embodiments of this invention, a system for operating a non-networked multi-user document device comprises: at least one multi-user document device; an interface associated with the multi-user document device; and at least one resource device associated with at least one of the multi-user document device and the interface, wherein the resource device stores information for generating a device portal based on at least one of an identity of a user and at least one feature of the multi-user document device. In such embodiments, the multi-user document device is a standalone device.

According to this invention, a multi-user document device may be operated by inputting an identity of a user into a device portal of the multi-user document device, associating the identity of the user with a user identification device, and supplying the user identification device to the user. In other words, the system for operating the multi-user document device may provide the user with an identification device or provide information to the device that identifies the user. For example, supplying the user identification device to the user may comprise supplying an encoded card to the user.

The user identification device may be used to verify the identify the user of a multi-user document device and to access a personal portal associated with the user based on the verified identity of the user. Payment information, information that may be used to effectuate payment for use of the multi-user document device, may be associated with the user identification device. For example, information comprising an electronic monetary balance may stored on the user identification device. Alternatively, information such as a billing account or a billing address may be associated with the user identification device.

As described above, targeted advertising may be provided to the identified user via the personal portal. Further, a reward may be associated with the identity of the user based on use of the multi-user document device via the personal portal.

It should be appreciated that various combinations of the above-described features may be used in the various systems and methods of this invention. As such, the following description of exemplary embodiments is not meant to be exhaustive, but rather illustrative for the sake of understanding by one skilled in the art.

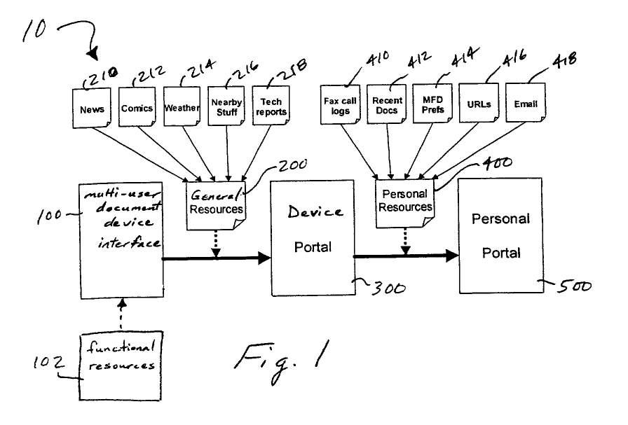

FIG. 1 shows a schematic representation of a system 10 for operating a networked multi-user document device according to this invention. As shown, a multi-user document device such as a multi-function device (MFD) is provided with functional resources 102. The functional resources 102 includes any data or information that is needed for execution of the various functions of the multi-function device. For example, the functional resources 102 may include software and/or databases incorporated into the multi-user document device. The functional resources 102 are accessed by an interface 100 of the multi-user document device to operate the multi-user document device in a known manner.

The multi-user document device may be provided with access to general resources 200, for example by connecting the multi-user document device and/or the interface 100 to a network. Such a network may be implemented as a client/server local area network or any known or later developed system for interconnecting multiple elements. Such networks include but are not limited to, for example, wide area networks, intranet, the Internet, or any other type of distributed network.

As represented in FIG. 1, the general resources 200 are used to generate a device portal 300 that combines the functionality of the interface 100 with access to information and/or resources that may be utilized with or may utilize the functionality or operating capabilities of the multi-user document device. As shown, the general resources 200 may include various informational resources such as news 210, comics 212, weather 214, local information 216 and technical reports 218. The general resources 200 may provide information based on a feature of the multi-user document device, such as the location of the multi-user document device and/or the owner or manufacturer of the multi-user document device. For example, the news 210 and the weather 214 may provide information that is specific to the local of the multi-user document device. Also, for example, when the multi-user document device is located at and/or owned by a particular business, relevant technical reports 218 may be provided. The local information 216 may include, for example, advertising for nearby businesses.

The multi-user document device may also be provided with access to personal resources 400, for example by connecting the multi-user document device and/or interface 100 to a network. As represented in FIG. 1, the personal resources 400 are used to generate a personal portal 500 that combines the functionality of the interface 100 with access to information and/or resources that may be utilized with or may utilize the functionality or operating capabilities of the multi-user document device. The personal portal 500 is personalized based on the identity of a user by providing access to the personal resources 400 of the identified user of the multi-user document device. The personal portal 500 may, but need not involve the general resources 200 associated with the device portal 300.

As shown, the personal resources 400 may include various informational resources such as facsimile call logs 410, recent documents 412, user preferences for the multi-user document device 414, website addresses 416 and e-mail 418. The personal resources 400 provide information based on the identity of the user of the multi-user document device so that only the identified user has access to the personal resources 400. Thus, the personal portal 500 is secure against unauthorized use and unauthorized access to the personal resources 400.

It should be understood that while the schematic representation of FIG. 1 is described above as providing access to the general and/or personal resources 200 and 400 by connecting the multi-user document device and/or interface 100 to a network, the general and/or personal resources 200 and 400 may be associated with the multi-user document device itself and/or a user identification device (described hereafter) so that the systems and methods of this invention may be implemented for a non-networked device.

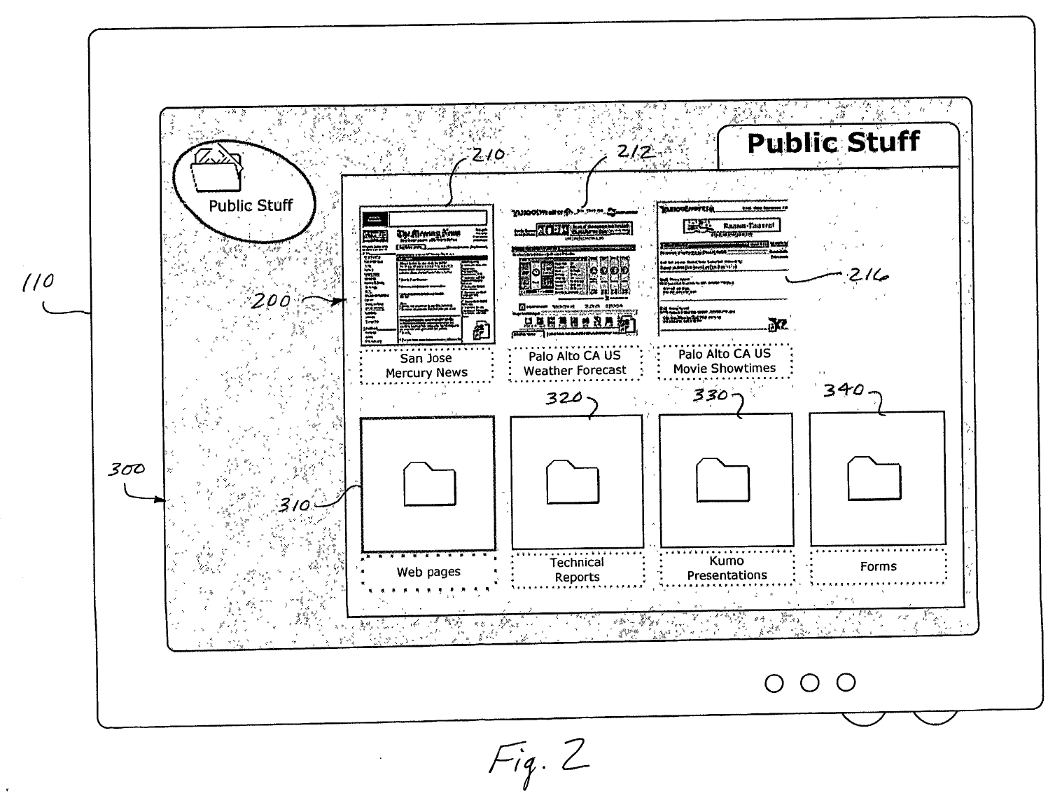

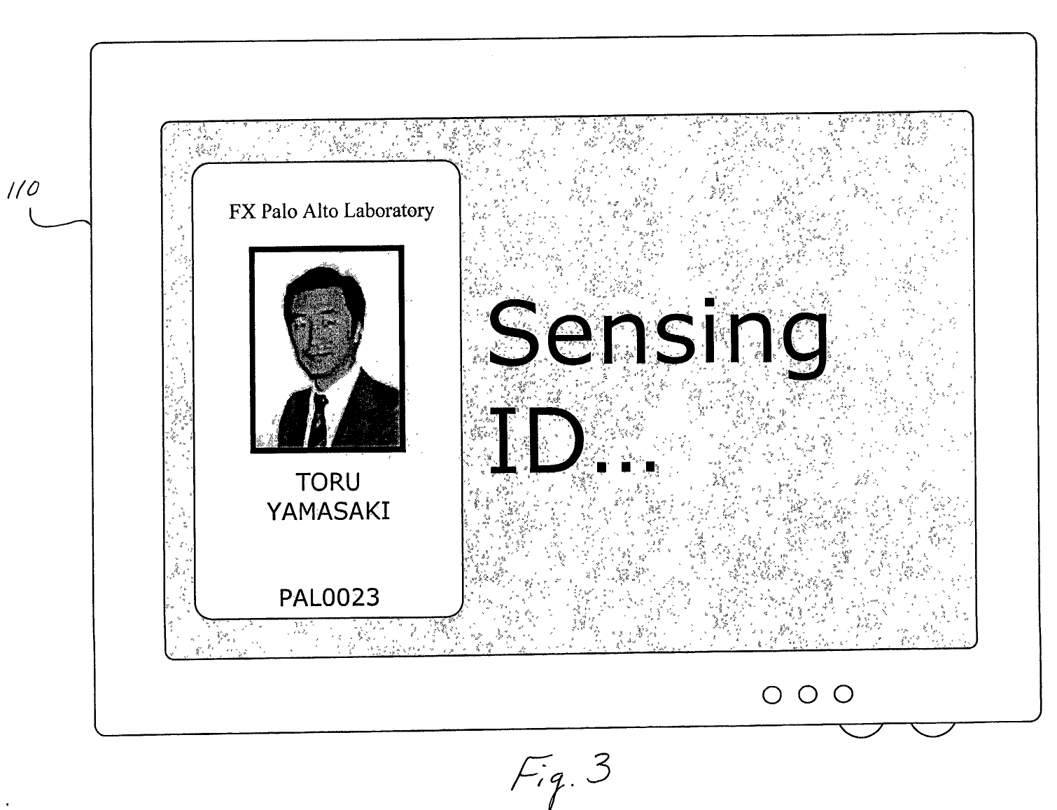

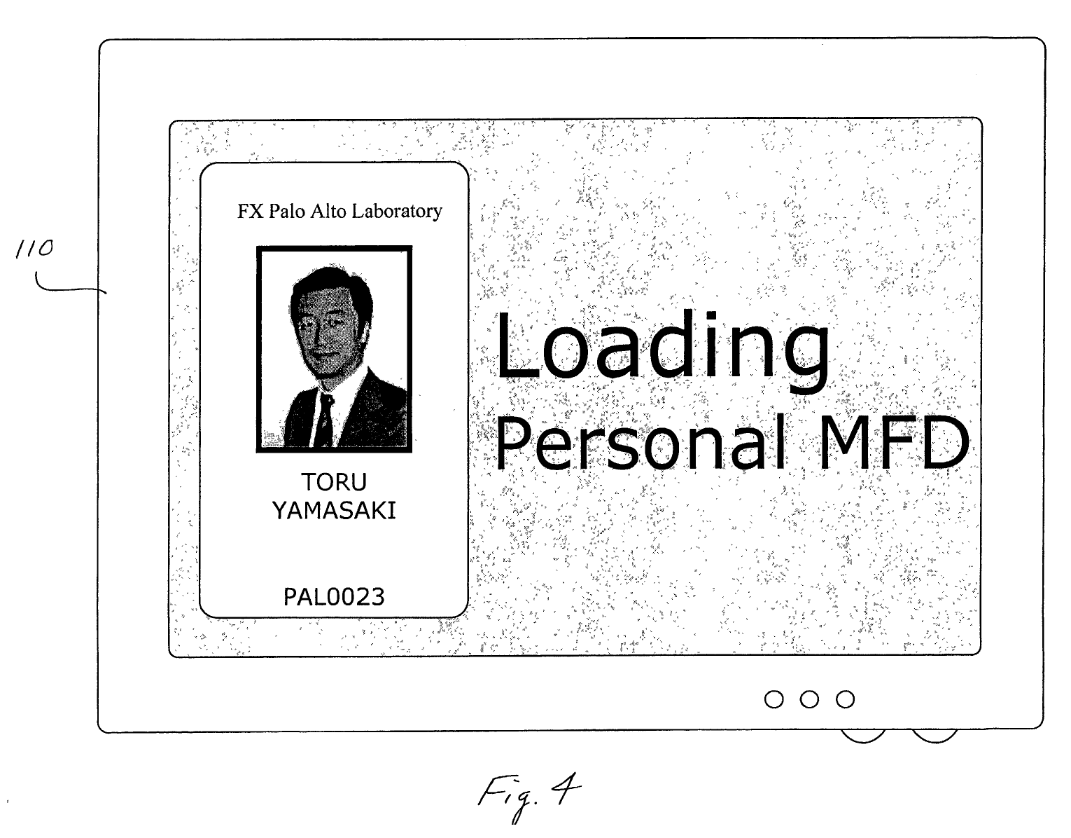

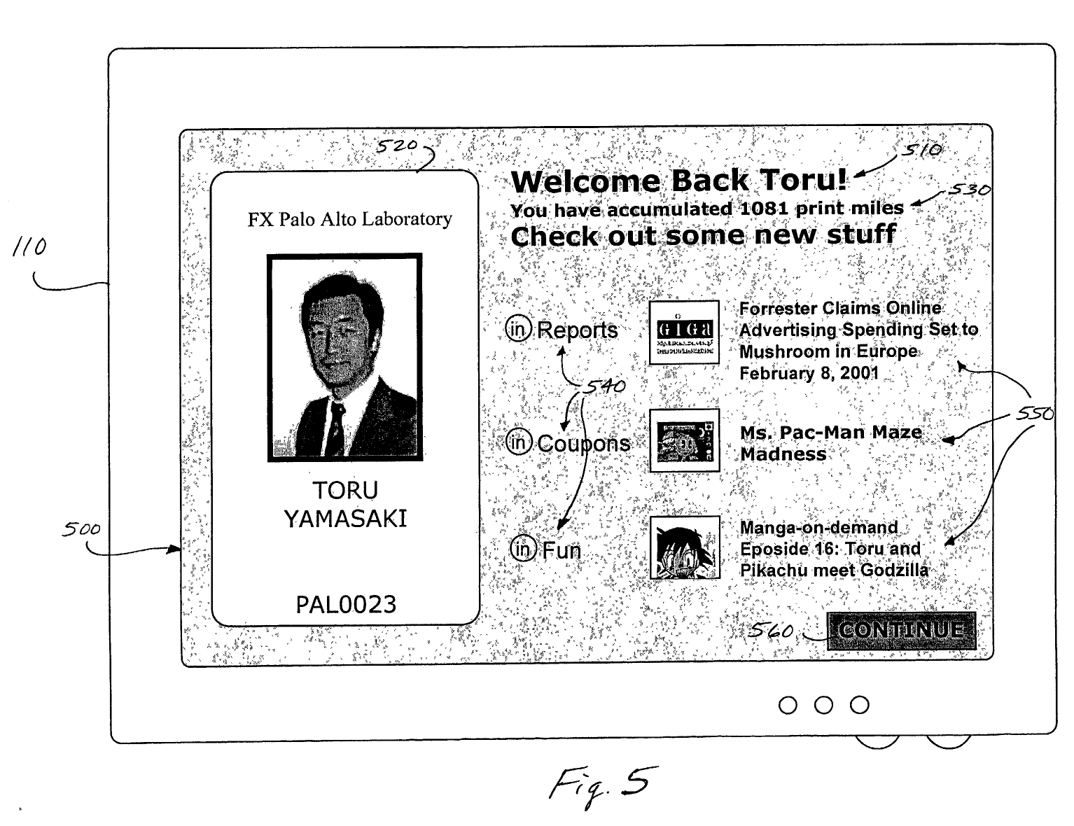

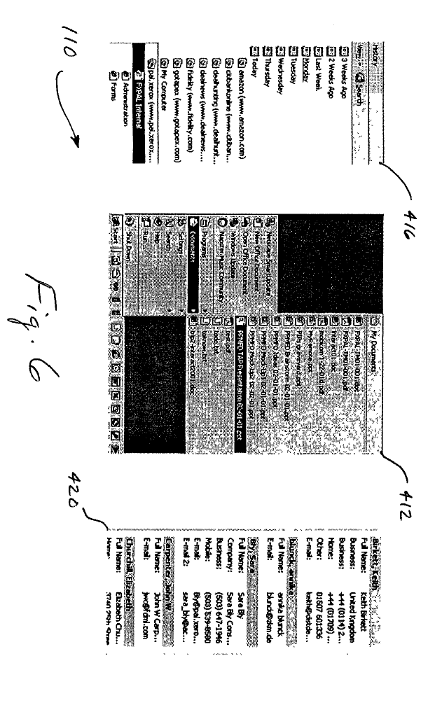

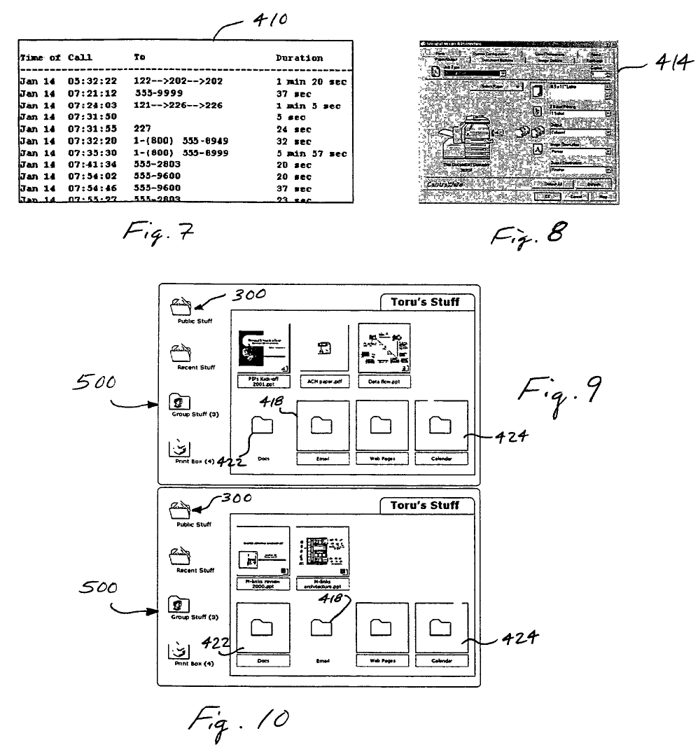

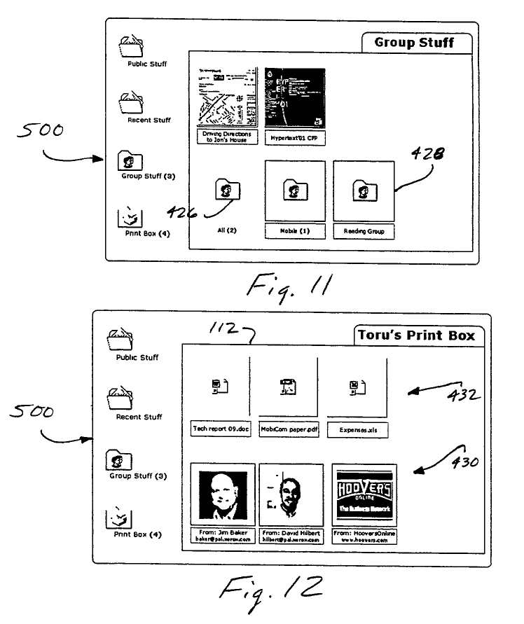

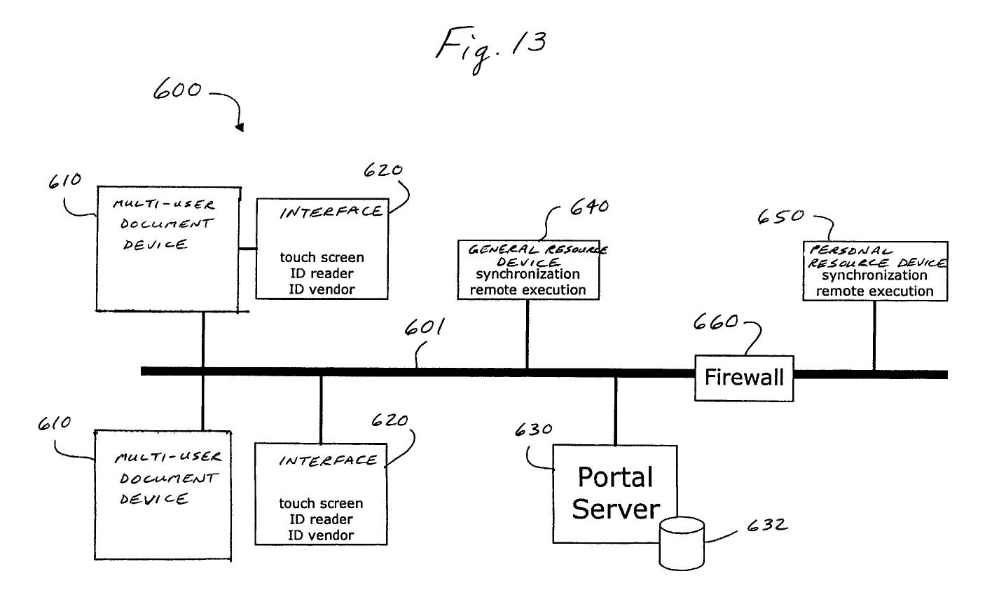

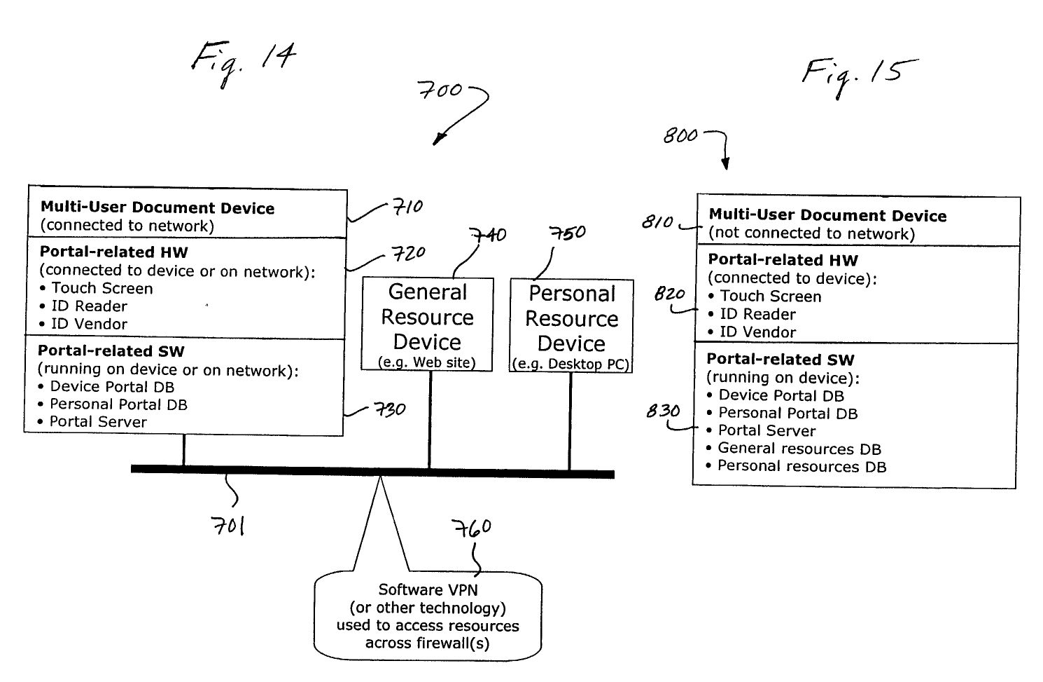

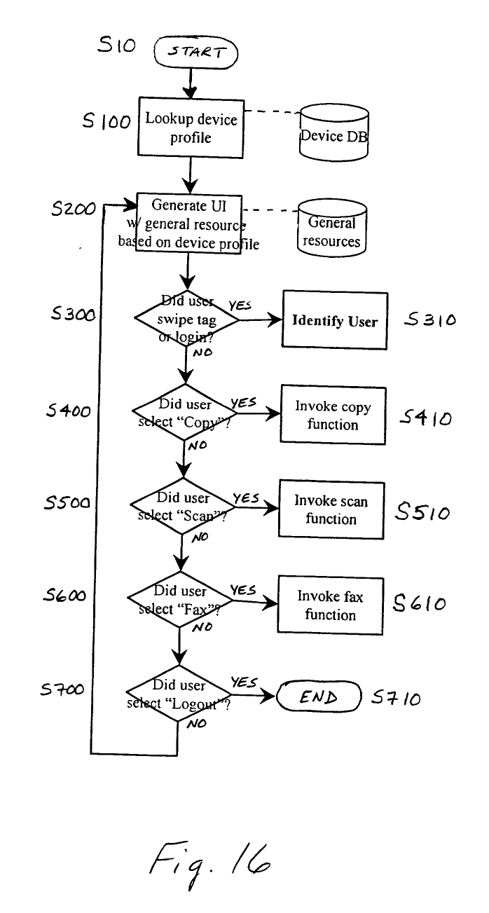

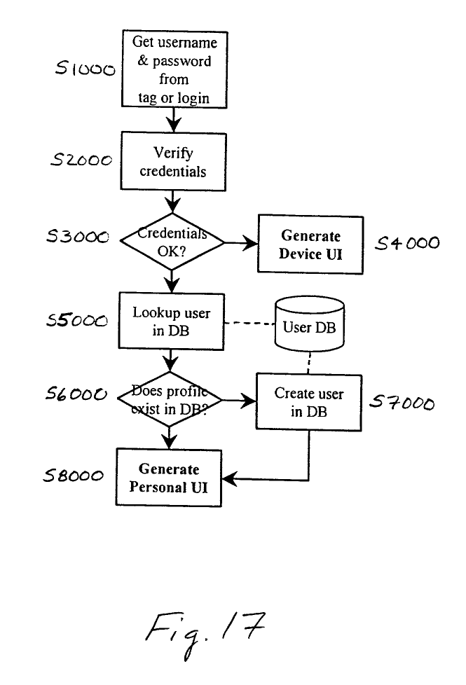

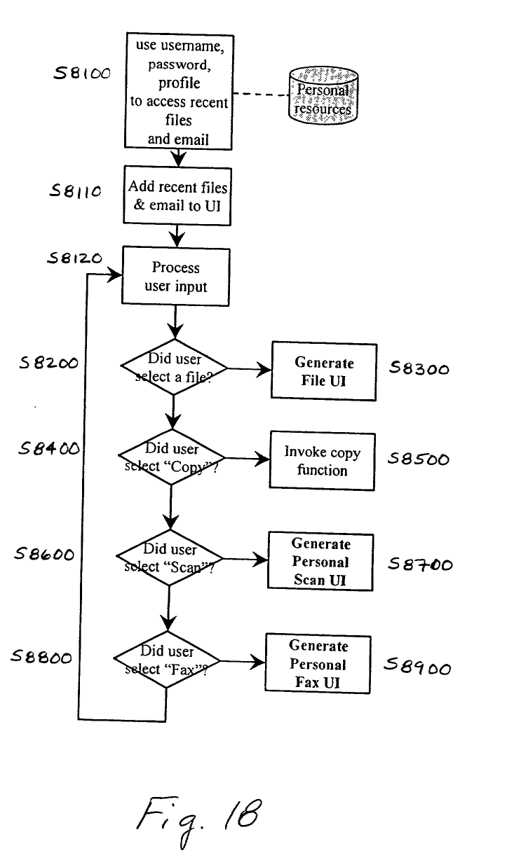

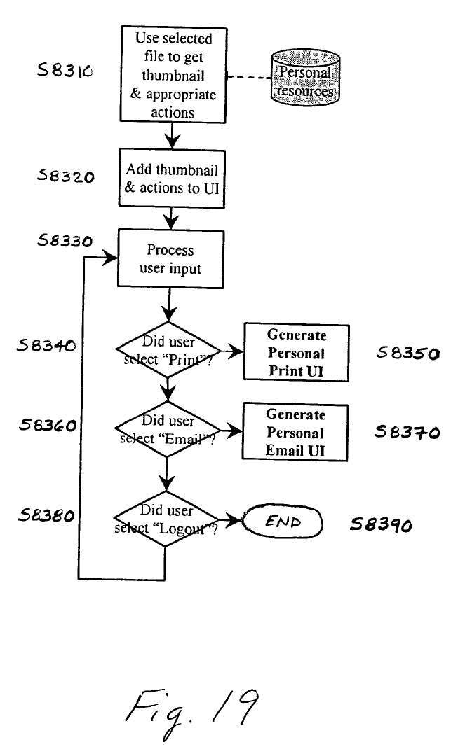

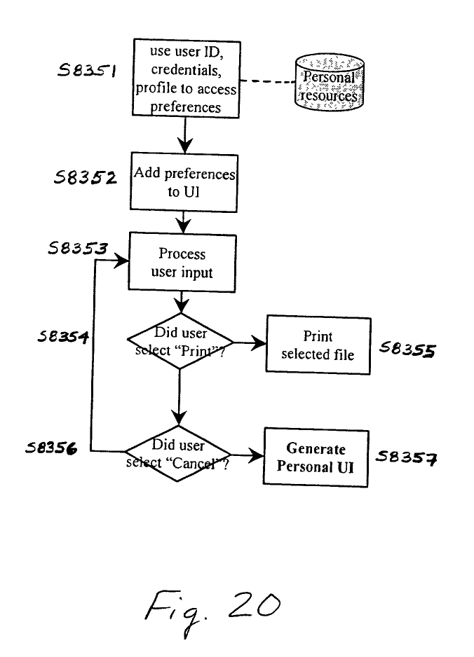

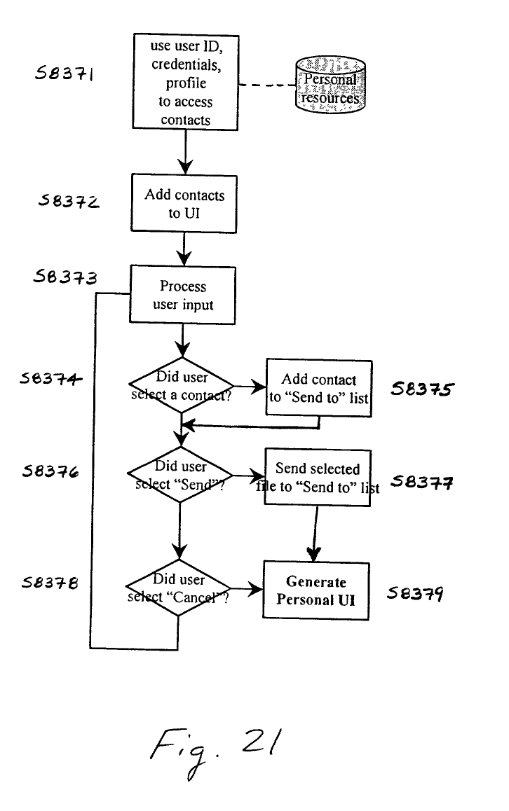

FIG. 2 shows an exemplary representation of an interface display 110 of the general resources 200 associated with the device portal 300 according to this invention. As shown in FIG. 2, the device portal 300 provides access to various public information, for example, by selecting from various icons or folders for web pages of general interest 310, technical reports 320, presentations 330 and/or general forms 340. For example, the user may select the web pages icon 310 to access the news 210 as an electronic version of a particular regional or local newspaper. Similarly, the user may access the weather 212 as an electronic source of regional or local weather. Other accessible local information 216 may be, for example, showtimes for movies at theaters that are located in the general vicinity of the multi-user document device.

FIG. 3 is an exemplary representation of the interface display 110 when identifying a user of the multi-user document device according to this invention. A user identification device is used to identify the user to the interface 100. In various embodiments, the user identification device may be a key entry associated with the user, such as a login and/or a password. In the embodiment represented by FIG. 3, an ID of a user, such as an electronic tag, may be sensed or detected by the interface 100. The electronic tag may be of any known or hereafter developed type, such as, for example, a magnetically encoded card, a credit card, a smart card or the like.

The interface 100 may include or may be in communication with a biometric measurement device so that a biometric measurement of the user may be used as the user identification device. Biometric measurements of a user include various human characteristics that are unique to individuals, such as fingerprints, retina scans, voiceprints and electronic signatures. Any suitably unique biometric measurement may be used, either known or hereafter developed. For example, one may envision the use of a DNA sample to identify a user.

Once the user of the multi-user document device is identified, the personal portal 500 for the identified user is loaded at the interface 100. In this sense, loading the personal portal 500 may comprise providing the interface display 110 with icons that represent the personal resources 400 described above with respect to FIG. 1. FIG. 4 is an exemplary representation of the interface display 110 when loading the personal portal 500 according to this invention.

FIG. 5 is an exemplary representation of the interface display 110 of the personal portal 500 according to this invention. The interface display 110 of the personal portal 500 may include a personal greeting 510 for the identified user and/or personal information such as the user's ID 520 and/or account information 530. Various other icons or buttons may be selected by the user to access various information categories 540. Additionally, the interface display 110 may include headlines or summaries 550 for information that is of particular interest to the identified user. Additional screens or pages of the personal portal 500 also may be displayed by selection of an icon or button 560, for example, to display the personal resources 400 for the identified user.

FIGS. 6-12 are exemplary representations of the personal resources 400 associated with the personal portal 500 according to this invention. FIG. 6 illustrates some of the Desktop-related personal resources 400 that users may access via the personal portal 500. As noted above and illustrated in FIG. 6, the personal resources 400 may include website addresses 416, including history and/or bookmarked web pages, and recent documents 412, such as documents recently accessed from a personal computer or network. The personal resources 400 also may include personal contact information 420 for the identified user.

As illustrated in FIGS. 7 and 8, respectively, the personal resources 400 accessible via the personal portal 500 may include previous interaction history, such as facsimile call logs 410, and user preferences for the multi-user document device 414, such as print preferences, for the identified user. As illustrated in FIGS. 9 and 10, the personal portal 500 may include access to the various information resources provided by the device portal 300 as well as personal resources such as documents/desktop resources 422, e-mail 418 and other information, such as calendar information 424 for appointments and the like. Other personal resources include faxes and/or scans.

In addition to providing access to personal resources 400 that are specific to and accessible only by the identified user, the personal portal 500 may provide access to resources that are associated with a particular group or groups to which the identified user belongs. For example, the personal resources 400 may include icons or folders for all of the identified user's contacts 426 and/or for select interest groups, such as a reading group 428, as illustrated in FIG. 11.

The personal portal 500 may enable a unique interface for messaging such as e-mail communication. As illustrated in FIG. 12, documents that are accessed at the multi-user document device may be shared between different users via their own personal portals. For example, the personal portal 500 may include icons representing individuals 430 that are associated with contact information, such as email addresses. Documents 432 selected by the identified user may then be directed to the desired individuals by “dragging” the documents 432 to the appropriate icons 430. As illustrated, a special print box interface 112 may be used as the display interface for such an application.

FIG. 13 is an exemplary block diagram of a system 600 for operating a multi-user document device according to this invention. The system 600 comprises one or more multi-user document devices 610, an interface 620 associated with each of the multi-user document devices 610, a portal server 630 and a network 601 connected to the portal server 630 and at least one of the multi-user document devices 610 and the interfaces 620 associated with the multi-user document devices 610. According to this invention, the portal server 630 generates a device portal based on at least one of an identity of a user and at least one feature of the multi-user document device 610. The portal server 630 provides the device portal to the interface 620 associated with the multi-user document device 610 via the network 601. While the portal server 630 is shown as a separate device on the network 601, it should be understood that the portal server 630 may be on the multi-user document device 610.

The network connection 601 may be any known or later developed device or system for connecting and integrating such a system. For example, the network connection 601 may comprise a direct cable connection, a connection over a wide area network or local area network, a connection over an intranet, a connection over the Internet, or a connection over any other distributed processing network or system, including wireless.

As shown in FIG. 13, the multi-user document device 610 may be connected to the network 601 with the associated interface 620 connected to the multi-user document device 610. Alternatively, both the multi-user document device 610 and the associated interface 620 may be connected to the network 601.

In the embodiment shown, the system 600 includes at least one resource device connected to the network 601, specifically a general or public resource device 640 and a personal resource device 650. In the case of the personal resource device 650, a firewall 660 may be used. It should be understood, however, that the personal resource device 650 may be outside of the firewall 660, depending on the desired level of security.

The general resource device 640 and/or the personal resource device 650 may be implemented as a networked personal computer or as a networked repository. It should be appreciated that the system can also be implemented using a general purpose computer, a special purpose computer, a programmed microprocessor or a micro-controller and peripheral integrated circuit elements, an application specific integrated circuit, or other integrated circuit, a hard-wired electronic or logic circuit such as a discrete element circuit, a programmable logic device such as a PLD, PLA, FPGA or PAL, or the like.

The systems and methods of this invention may be implemented as a combination of custom-developed software and commercially available hardware and software, which together perform the following tasks: identifying users; providing the user interface; accessing users' personal information; and, controlling the multi-user document device. The task of identifying users can be accomplished using a commercially available electronic ID card system, such as, for example, the Texas Instruments TagIt Radio Frequency Identification system. Custom-developed software may communicate with the electronic ID system, for example, via the Texas Instruments TagIt RFID protocol. A commercially available database, such as, for example, Microsoft Access, may be used to associate a user's electronic ID number with data necessary to access that user's personal information and/or resources over a network, such as, for example, a Microsoft Windows NT network. The task of providing a portal user interface to the user can be accomplished using commercially available hardware and software, such as, for example, a touch screen LCD, an optional wireless keyboard and mouse, and a computing device running Microsoft Windows. Custom-developed software may be run on a commercially available Web server program, such as, for example, Microsoft's Internet Information Services, to generate a Web-based user interface to the user via the touch screen display. The task of allowing users to access their personal information and/or resources via the portal can be accomplished by custom-developed software that receives a user's username and password as inputs and “impersonates” the user on the network, for example, via the Microsoft Windows API. The custom-developed software may use existing APIs, such as, for example, the Microsoft Windows API, to access the user's documents and to generate appropriate thumbnails and icons, and other existing APIs, such as, for example, the Microsoft Outlook API, to access the user's address book and email. The custom-developed software may also rely on commercially available technologies, such as, for example, software VPN technology, to allow users to access their personal information across firewalls. The task of allowing users to control the multi-user document device via the portal user interface can be accomplished by custom-developed software that communicates with an API provided by the device, such as, for example, the Xerox CentreWare API.

The portal server 630 includes or has access to a server database 632. The server database 632 stores data for the device portals and/or personal portals for each of the multi-user document devices 610. Also, the server database 632 may be used to store the general resources and/or personal resources rather than using the general resource device 640 and the personal resource device 650.

The interface 620 may include a user identification device such as hardware and/or software for identifying the user of the multi-user document device 610. For example, the interface may include a keyboard or touch screen for entry of a key entry, such as a username and/or password. Alternatively or additionally, a biometric measurement device, a sensor or reading device, and/or a receiving device may be included to identify the user, as noted above.

FIG. 14 is another exemplary block diagram of a system 700 for operating a networked multi-user document device according to this invention. The system 700 comprises at least one multi-user document device 710, portal-related hardware 720 associated with each multi-user document device 710, portal-related software 730 and a network 701 in communication therewith. According to the exemplary system, the multi-user document device 710 is connected to the network 701. The network 701 may be any known or later developed device or system for connecting and integrating such a system. For example, the network 701 may comprise a direct cable connection, a connection over a wide area network or local area network, a connection over an intranet, a connection over the Internet, or a connection over any other distributed processing network or system, including wireless.

The portal-related hardware 720 may be connected to either the multi-user document device 710 or the network 701. The portal-related hardware 720 may comprise a touch screen, an ID reader and/or an ID vendor. Similarly, the portal-related software 730 may be run on either the multi-user document device 710 or the network 701. The portal-related software 730 may comprise a device portal database, a personal portal database and/or a portal server.

In the embodiment shown, the system 700 includes at least one resource device connected to the network 701. Specifically, a general or public resource device 740 and a personal resource device 750 are illustrated. In the case of the personal resource device 750, a firewall (not shown) may exist. In such a case, suitable software 760, such as VPN software, may be included to access the personal resource device 750 across the firewall.

FIG. 15 is an exemplary block diagram of a system 800 for operating a non-networked multi-user document device according to this invention. The system 800 comprises a multi-user document device 810, portal-related hardware 820 and portal-related software 830. According to the exemplary system, the multi-user document device 810 is connected to the portal-related hardware 820 and the portal-related software 830 is run on the multi-user document device 810.

Again, the portal-related hardware 820 may comprise a touch screen, an ID reader and/or an ID vendor. Similarly, the portal-related software 830 may comprise a device portal database, a personal portal database, a portal server and at least one resource device. Specifically, a general or public resource device and a personal resource device may be included.

FIGS. 14 and 15 illustrate basic features of networked and non-networked or standalone configurations for the systems of this invention. It should be apparent to those skilled in the art that other configurations are also possible. As such, FIGS. 14 and 15 are intended to illustrate non-limiting configurations for the sake of understanding.

FIGS. 16-23 are exemplary flowcharts illustrating a method for operating a multi-user document device according to this invention. As shown in FIG. 16, control begins at step S10. At step S100, the features of the multi-user document device are identified by looking up a profile for the device, for example, stored on a device database. For a networked multi-user document device, the device database may be on the device or the network. For a standalone, non-networked multi-user document device, the device database may be on the device.

Control continues to step S200, where a device portal is generated for the user interface of the multi-user document device based on the device profile. The device portal is generated with general resources that may be on the multi-user document device, or on the network for a networked device. Next, in step S300, a determination is made whether a tag, a user logon or other user input is received or detected. If so, control continues to step S310 where the user is identified.

If not, the user may operate the multi-user document device via the device portal using the general resources and the functions of the multi-user document device. As shown in step S400, a determination is made whether or not the user has selected a copy function of the multi-user document device. If so, control continues to step S410 where the copy function is invoked. As shown in step S500, a determination is made whether or not the user has selected a scan function of the multi-user document device. If so, control continues to step S5 10 where the scan function is invoked. As shown in step S600, a determination is made whether or not the user has selected a fax function of the multi-user document device. If so, control continues to step S610 where the fax function is invoked.

After each selected function is executed, the general resources may be updated and control proceeds to step S700. In step S700, a determination is made whether or not the user has selected to cancel operation of the multi-user document device. If not, control returns to step S200. If so, control proceeds to step S7 10 where the process ends.

FIG. 17 is an exemplary flowchart illustrating step S310 in more detail. In step S1000, information such as a username and password is obtained from the tag or login received or detected. The information or credentials of the user are processed in step S2000. Then, in step S3000, a determination is made whether or not the credentials of the user are okay. If not, control proceeds to step S4000 where control is returned to step S200 so that the user may operate the multi-user document device via the device portal.

If the credentials of the user are okay, control proceeds to step S5000 where a database of user information is accessed. This database may be on the multi-user document device for a standalone multi-user document device and may be on the multi-user document device or the network for a networked multi-user document device. Then, in step S6000, a determination is made whether or not a profile for the identified user exists in the database. If not, a user profile is created in the database in step S7000 and control returns to step S5000. If a profile for the identified user already exists in the database, control proceeds directly to step S8000 where a personal portal is generated.

FIG. 18 is an exemplary flowchart illustrating step S8000 in more detail. In step S8100, the username, password and/or profile is used to access a database of personal resources, such as recent document files and e-mail. The database of personal resources may be on the multi-user document device or on an ID device for a standalone multi-user document device, and may be on the multi-user document device, the ID device or the network for a networked multi-user document device. In step S8110, the recent files, e-mail or other information form the personal resource database is added to the user interface of the multi-user document device as a personal portal.

The user may then operate the multi-user document device via the personal portal using the personal resources and/or the general resources and the functions of the multi-user document device. In step S8120, user input is processed. As shown in step S8300, a determination is made whether or not the user has selected a file. If so, control continues to step S8300 where a personal file interface is generated. As shown in step S8400, a determination is made whether or not the user has selected a copy function of the multi-user document device. If so, control continues to step S8500 where the copy function is invoked. As shown in step S8600, a determination is made whether or not the user has selected a scan function of the multi-user document device. If so, control continues to step S8700 where a personal scan interface is generated. As shown in step S8800, a determination is made whether or not the user has selected a fax function of the multi-user document device. If so, control continues to step S8900 where a personal fax interface is generated.

After each selected function is executed, the personal resources and/or the general resources may be updated. Control may return to step S8120 for further user input. The process may end when the user selects a cancel function or after user input ceases for a specified period of time.

FIG. 19 is an exemplary flowchart illustrating step S8300 in more detail. In step S8310, the a thumbnail and/or actions associated with the selected file are accessed from the personal resource database. Then, in step S8320, the selected thumbnail and/or actions are added to the user interface of the multi-user document device via the personal portal.

The user may then operate the multi-user document device via the personal portal using the file, via the thumbnail and/or actions, and/or the general resources, and/or other personal resources and the functions of the multi-user document device. In step S8330, user input is processed. As shown in step S8340, a determination is made whether or not the user has selected a print function of the multi-user document device. If so, control continues to step S8350 where a personal print interface is generated. As shown in step S8360, a determination is made whether or not the user has selected an e-mail function of the multi-user document device. If so, control continues to step S8370 where a personal e-mail interface is generated.

After each selected function is executed, the personal resources and/or the general resources may be updated and control proceeds to step S8380. In step S8380, a determination is made whether or not the user has selected to logout or cancel operation of the multi-user document device. If not, control may return to step S8330. If so, control proceeds to step S8390 where the process ends.

FIG. 20 is an exemplary flowchart illustrating step S8350 in more detail. In step S8351, the user ID, credentials and/or profile are used to access preferences from the personal resource database. Then, in step S8352, the preferences are added to the user interface of the multi-user document device via the personal portal.

The user may then operate the multi-user document device via the personal portal using the preferences and the print function of the multi-user document device. In step S8353, user input is processed. As shown in step S8354, a determination is made whether or not the user has selected a print function of the multi-user document device. If so, control continues to step S8355 where the selected file is printed. If not, control continues to step S8356 where a determination is made whether or not the user has selected a cancel function of the multi-user document device. If not, control returns to step S8353. If so, control proceeds to step S8357 where control is returned to step S8000.

FIG. 21 is an exemplary flowchart illustrating step S8370 in more detail. In step S8371, the user ID, credentials and/or profile are used to access contacts from the personal resource database. Then, in step S8372, the contacts are added to the user interface of the multi-user document device via the personal portal.

The user may then operate the multi-user document device via the personal portal using the contacts and the e-mail function of the multi-user document device. In step S8373, user input is processed. As shown in step S8374, a determination is made whether or not the user has selected a contact. If so, control continues to step S8375 where the contact is added to a list of recipients for the email. Control then proceeds to step S8376. If the user has not selected a contact, control proceeds directly to step S8376.

In step S8376, a determination is made whether or not the user has selected a send function of the multi-user document device. If not, control jumps to step S8378 where a determination is made whether or not the user has selected a cancel function. If not, control returns to step S8373. If the user has selected the cancel function, control proceeds to step S8379.

If the user has selected a send function, control proceeds to step S8377 where the selected file is sent to the list of recipients. Control then proceeds directly to step S8379. In step S8379, control is returned to step S8000.

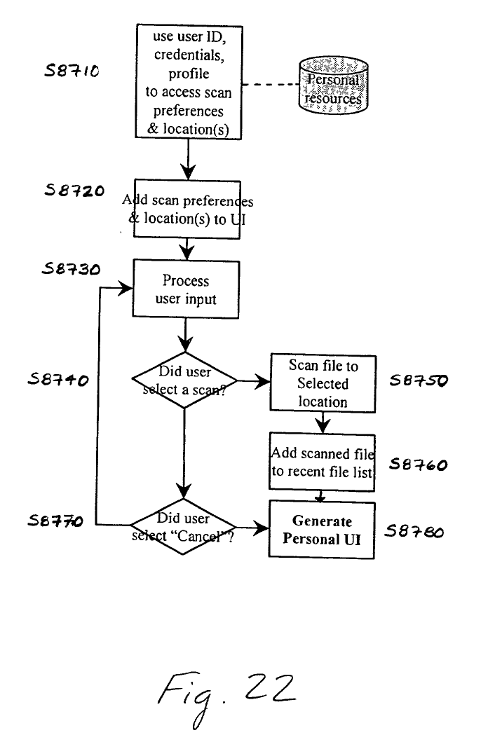

FIG. 22 is an exemplary flowchart illustrating step S8700 in more detail. In step S8710, the user ID, credentials and/or profile are used to access scan preferences and/or locations from the personal resource database. Then, in step S8720, the scan preferences and/or locations are added to the user interface of the multi-user document device via the personal portal.

The user may then operate the multi-user document device via the personal portal using the scan preferences and/or locations and the scan function of the multi-user document device. In step S8730, user input is processed. As shown in step S8740, a determination is made whether or not the user has selected a scan. If so, control continues to step S8750 where the selected file is scanned to a selected location. Then, in step S8760, the scanned file is added to a recent file list to update the personal resources. Control then jumps to step S8780.

If the user has not selected a scan, control proceeds directly to step S8770. In step S8770, a determination is made whether or not the user has selected a cancel function of the multi-user document device. If not, control returns to step S8730. If the user has selected the cancel function, control proceeds to step S8780. In step S8780, control is returned to step S8000.

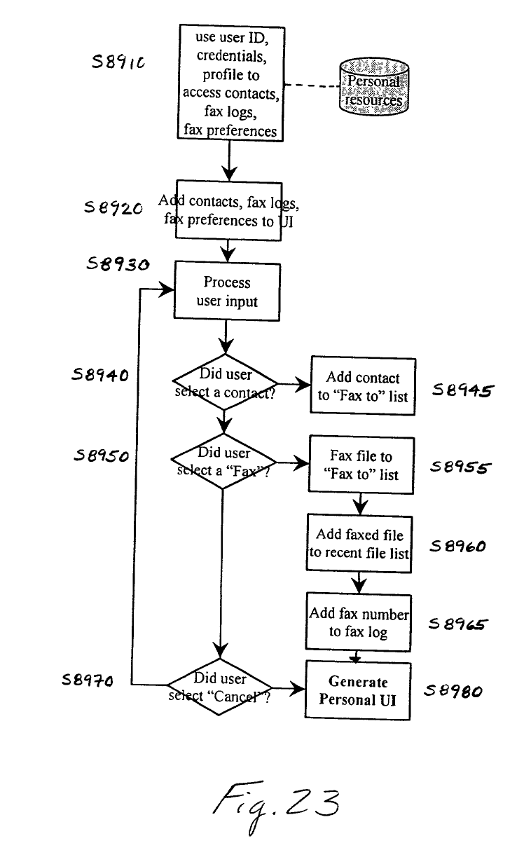

FIG. 23 is an exemplary flowchart illustrating step S8900 in more detail. In step S8910, the user ID, credentials and/or profile are used to access contacts, fax logs and/or fax preferences from the personal resource database. Then, in step S8920, the contacts, fax logs and/or fax preferences are added to the user interface of the multi-user document device via the personal portal.

The user may then operate the multi-user document device via the personal portal using the contacts, fax logs and/or fax preferences and the fax function of the multi-user document device. In step S8930, user input is processed. As shown in step S8940, a determination is made whether or not the user has selected a contact. If so, control continues to step S8945 where the contact is added to a list of recipients for the fax. Control then proceeds to step S8950. If the user has not selected a contact, control proceeds directly to step S8950.

In step S8950, a determination is made whether or not the user has selected a fax function of the multi-user document device. If not, control jumps to step S8970 where a determination is made whether or not the user has selected a cancel function. If not, control returns to step S8930. If the user has selected the cancel function, control proceeds to step S8980.

If the user has selected a fax function, control proceeds to step S8955 where the selected file is sent to the list of recipients. Then, in step S8960, the faxed file is added to a recent file list to update the personal portal. Then, in step S8965, the fax number is added to the fax log to update the personal resources. Control then jumps to step S8980. In step S8980, control is returned to step S8000.

While this invention has been described in conjunction with specific embodiments thereof, it is evident that many alternatives, modifications and variations will be apparent to those skilled in the art. Therefore, exemplary embodiments of the invention as set forth herein are intended to be illustrative and not limiting. Various changes may be made without departing from the spirit and scope of the invention.

What is claimed is:

1. A method for operating a networked or non-networked multi-user document device, comprising:
providing a multi-user document device with a device portal; and
providing a user of the multi-user document device with information via the device portal based on at least one of an identity of the user and at least one feature of the multi-user document device.

2. The method of claim 1, wherein providing the user of the multi-user document device with information via the device portal is based on at least one feature of the multi-user document device and comprises accessing resources associated with the at least one feature of the multi-user document device.

3. The method of claim 2 wherein providing the user of the multi-user document device with information via the device portal is based on the at least one feature of the multi-user document device and comprises providing targeted advertising to the user via the device portal.

4. The method of claim 1, wherein providing the user of the multi-user document device with information via the device portal is based on the location of the multi-user document device and comprises accessing resources associated with the location of the multi-user document device.

5. The method of claim 4, wherein providing the user of the multi-user document device with information via the device portal is based on the location of the multi-user document device and comprises providing targeted advertising to the user via the device portal.

6. The method of claim 1, wherein providing the user of the multi-user document device with information via the device portal is based on the identity of the user, further comprising:
identifying the user of the multi-user document device; and
accessing a personal portal for the identified user.

7. The method of claim 6, wherein identifying the user of the multi-user document device comprises at least one of detecting an electronic tag associated with the user, reading an encoded card associated with the user, receiving a key entry associated with the user, analyzing a biometric measurement and receiving a signal from a remote device operated by the user.

8. The method of claim 6, wherein accessing the personal portal for the identified user comprises accessing personal resources stored on one or more devices.

9. The method of claim 6, further comprising:
identifying the same user of a second multi-user document device; and
accessing a second personal portal for the identified user that provides information that is shared with the other personal portal for the identified user.

10. The method of claim 6, further comprising storing at least one interaction of the user with a multi-user document device, wherein accessing the personal portal comprises accessing the stored at least one interaction of the user.

11. The method of claim 6, further comprising providing, to the identified user via the personal portal, information that is personalized for the identified user.

12. The method of claim 6, further comprising providing targeted advertising to the identified user via the personal portal.

13. The method of claim 6, further comprising associating a reward with use of at least one select multi-user document device.

14. A system for operating a networked multi-user document device, comprising:
at least one multi-user document device;
an interface associated with the multi-user document device;
a portal server that generates a device portal based on at least one of an identity of a user and at least one feature of the multi-user document device; and
a network in communication with the multi-user document device, wherein the portal server provides the device portal to the interface associated with the multi-user document device by accessing at least one resource via the network.

15. The system of claim 14, further comprising at least one resource device in communication with the network, the resource device storing information associated with a location of the multi-user document device, the portal server generating the device portal by accessing the information associated with the location of the multi-user document device stored by the resource device.

16. The system of claim 14, further comprising at least one resource device in communication with the network, the resource device storing information associated with the multi-user document device, the portal server generating the device portal by accessing the information associated with the multi-user document device stored by the resource device.

17. The system of claim 14, further comprising a user identification device associated with a user of the multi-user document device that identifies the user to the portal server.

18. The system of claim 17, wherein the user identification device comprises at least one of a key entry, an electronic tag, an encoded card, a biometric device and a signal from a remote device operated by the user.

19. The system of claim 17, further comprising at least one personal resource device connected to the network, the personal resource device storing information associated with the identified user, the portal server generating the device portal by accessing the information associated with the identified user stored by the personal resource device.

20. A system for operating a non-networked multi-user document device, comprising:
at least one multi-user document device;
an interface associated with the multi-user document device; and
at least one resource device associated with at least one of the multi-user document device and the interface, wherein the resource device stores information for generating a device portal based on at least one of an identity of a user and at least one feature of the multi-user document device.

21. The system of claim 20, wherein the resource device stores information associated with a location of the multi-user document device and the device portal is generated based on the location of the multi-user document device.

22. The system of claim 20, wherein the resource device stores information associated with the multi-user document device and the device portal is generated based on the information associated with the multi-user document device.

23. The system of claim 20, further comprising a user identification device associated with a user of the multi-user document device that identifies the user to the interface, wherein the device portal is generated based on the identity of the identified user.

24. The system of claim 23, wherein the user identification device comprises at least one of a key entry, an electronic tag, an encoded card, a biometric device and a signal from a remote device operated by the user.

25. The system of claim 23, further comprising at least one personal resource device associated with at least one of the multi-user document device, the interface and the user identification device, wherein the personal resource device stores information associated with the identified user and the device portal is generated by accessing the information associated with the identified user stored by the personal resource device.

26. A method for operating a multi-user document device, comprising:
inputting an identity of a user into a device portal of a multi-user document device;
associating the identity of the user with a user identification device; and
supplying the user identification device to the user.

27. The method of claim 26, further comprising associating payment information with the user identification device.

28. The method of claim 26, wherein supplying the user identification device to the user comprises supplying an encoded card to the user.

29. The method of claim 26, further comprising:
using the user identification device to verify the identify the user of a multi-user document device; and
accessing a personal portal associated with the user based on the verified identity of the user.

30. The method of claim 29, further comprising providing targeted advertising to the user via the personal portal.

31. The method of claim 30, further comprising associating a reward with the identity of the user based on use of the multi-user document device via the personal portal.
